(19) United States
(12) Patent Application Publication
(10) Pub. No.: US 2015/0235274 A1
(43) Pub. Date: Aug. 20, 2015

(54) REAL-TIME ANALYTICAL APPLIANCE AND SYSTEM

(71) Applicant: Enmanuel D. Rumbos, Vineland (CA)

(72) Inventor: Enmanuel D. Rumbos, Vineland (CA)

(21) Appl. No.: 14/627,373

(22) Filed: Feb. 20, 2015

(30) Foreign Application Priority Data
Feb. 20, 2014 (CA) 2843104

(51) Int. Cl. G06Q 30/02

(52) U.S. Cl. CPC G06Q 30/0268

(57) ABSTRACT

A data collection device and a data collection and analysis system to receive and enable real-time analysis of product information of a retail transaction is disclosed. The data collection device connects between a data capture device and a point-of-sale terminal and is configured to receive coded data from the data capture device. The data collection device can copy the coded data and forward the coded data to the point-of-sale terminal in its raw form and to an analysis server as analytics data. Time data and location data can also be transmitted by the data collection device to the analysis server. The analysis server processes the analytics data to reveal product information and compares the product information, time data and location data with correlations based on historical data sets. The analysis server can deliver product focused advertisements in real-time.

### FIELD OF THE INVENTION

The present disclosure relates to the field of real-time collection and analysis of product data from retail transactions.

### BACKGROUND

Retailers are increasingly relying on analytical insights to make decisions related to their footprints, product assortment, merchandising strategies and suggestive selling. Under the current retail deployment model, data obtained from point-of-sale systems is primarily geared towards inventory control, logistics and accounting practices. Marketing departments across all retailers are relying on transactional data to make decisions and build customer profiles. The biggest challenge presented today when it comes to transactional insights is the disconnect between the point-of-sale platforms and marketing insights.

There are significant barriers to effectively distil all the point of sale data collected into actionable marketing insights, such as data format, volume of data and data structure, along with real-time activation.

Specifically, CA2,790,347 refers to point-of-sale advertising methods. The technology disclosed therein is required to be fully integrated to a point-of-sale system and the relevancy of data is determined by profiling a credit card user.

CA2,393,455 also refers to point-of-sale advertisement and is based on loyalty cards recognition and product association, however it also requires full integration with a point-of-sale system of the retailer.

While these publications generally describe point of sale advertising relevant to the customer profile, they each have to be fully integrated with the retailer point-of-sale system to perform. There is therefore a need for a data collection device and system to collect product data from retail transactions in real-time and to use product data collected in real-time to deliver focused advertisements.

### SUMMARY

A data collection device and a data collection and analysis system to receive and enable real-time analysis of product information of a retail transaction is disclosed. The data collection device connects between a data capture device (e.g. a bar code or other product scanner) and a point-of-sale terminal and is configured to receive coded data from the data capture device. The data collection device can receive or capture the coded data and forward the coded data to the point-of-sale terminal in its raw form and to an analysis server as analytics data. Time data and location data can also be transmitted by the data collection device to the analysis server. The analysis server processes the analytics data to reveal product information and compares the product information, time data and location data with correlations based on historical data sets. The analysis server can deliver product focused advertisements in real-time.

Additional aspects of the devices, systems, methods, etc. will be apparent in view of the description which follows. It should be understood, however, that the detailed description and the specific examples, while indicating specific embodiments of the invention, are given by way of illustration only, various changes and modifications will become apparent to those skilled in the art from this detailed description.

### BRIEF DESCRIPTION OF THE DRAWINGS

Further features and advantages of the present disclosure will become apparent from the following detailed description, taken in combination with the appended drawings, in which:

FIG. 1 shows a schematic diagram of an exemplary real-time data collection and analysis system;

FIG. 2 shows a schematic diagram of an exemplary real-time data collection device; and

FIG. 3 shows a flow chart of data flow through the exemplary real-time data collection and analysis system of FIG. 1.

### DETAILED DESCRIPTION

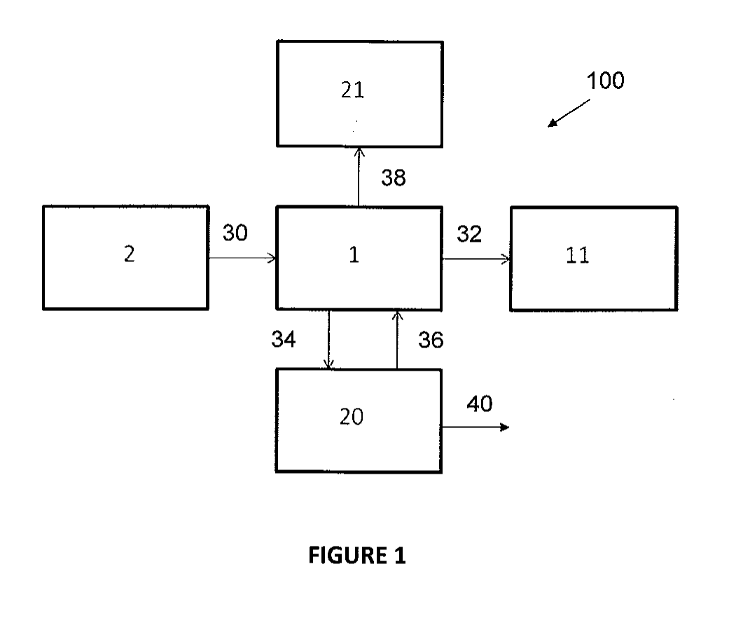

Embodiments are described below, by way of example, with reference to FIGS. 1, 2 and 3. The embodiments described and depicted herein provide a real-time data collection device and a real-time data collection and analysis system where the data collection device and data collection and analysis system seamlessly integrate into a retailer's point-of-sale system. The data collection and analysis system can compare product data to correlations generated from historical product data collected by the real-time data collection device to deliver product-focused advertisements in real-time.

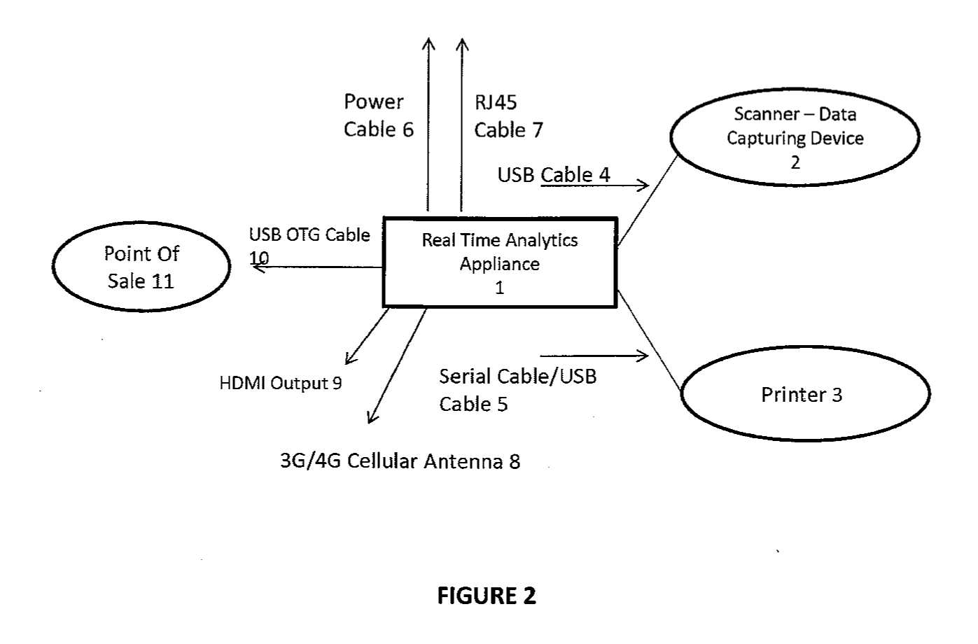

FIG. 1 depicts an example embodiment of real-time data collection and analysis system 100. Central to system 100 is real-time analytics appliance 1. FIG. 2 depicts a schematic diagram of an example real-time analytics appliance 1. Real-time analytics appliance 1 is used to collect data (e.g. product data) from products purchased in retail transactions. In the example embodiment, real-time analytics appliance 1 has one or more communication sub-systems (not shown) to enable connection to point-of-sale terminal 11 through cable connection 10 (e.g. USB OTG cable) and to data capturing device 2 through cable connection 4 (e.g. USB cable). Real-time analytics appliance 1 can also optionally be connected to printer 3 through cable connection 5 (e.g. serial cable/USB). Real-time analytics appliance 1 further comprises a power connection through power cable 6 and input/output connections through RJ45 cable 7, HEMI output 9, and 3G/4G cellular antenna 8. Uses of these communication capabilities will be discussed below.

Data capturing device 2 (e.g. scanner) captures coded data 30 and delivers coded data 30 in real-time to real-time analytics appliance 1 through cable connection 4. In the example embodiment, data capturing device 2 is a bar code (e.g. UPC) scanner that uses a light source and a sensor to read a traditional bar code on or attached to a product. It should be noted that data capturing device 2 can be any coded image reading device capable of reading and obtaining coded product data from a product.

Coded data 30 received at real-time analytics appliance 1 from data capturing device 2 is generally bar code data in its raw form, however, coded data 30 received from data capturing device 2 can also optionally be time-stamped by data capturing device 2 prior to being received by real-time analytics appliance 1 and therefore include a time and/or date at which the coded data 30 was captured by data capturing device 2.

Real-time analytics appliance 1 receives coded data 30 from data capturing device 2. In the example embodiment, real-time analytics appliance 1 is placed between data capturing device 2 and point-of-sale terminal 11 such that coded data 30 captured by data capturing device 2 can pass through real-time analytics appliance 1 before being transmitted to point-of-sale terminal 11 as data 32. In this configuration, software stored on at least one processor and/or memory of real-time analytics appliance 1 can provide customized instructions to real-time analytics appliance 1 to emulate a point-of-sale terminal to data capture device 2 and similarly to emulate a data capture device to point-of-sale terminal 11. As real-time analytics appliance 1 can be customized to emulate data capture device 2 or point-of-sale terminal 11 pursuant to instructions from program software, real-time analytics appliance 1 can be implemented in a “plug-and-play” scenario in which the retailer/user hosting real-time analytics appliance 1 can connect an existing data capturing device 2 and point-of-sale terminal 11 to real-time analytics appliance 1 and not require any additional hardware or software integration. Real-time analytics appliance 1 forwards data 32 to point-of-sale 11 in a transparent manner.

For instance, real-time analytics appliance 1 can utilize cellular connectivity through 3G/4G cellular antenna 8 to have communication independence and therefore not require use of a virtual private network of a retailer hosting the system 100.

In one embodiment, real-time analytics appliance 1 employs a kernel to manage input/output requests from data capture device 2 and translate these requests into data processing instructions for a central processing unit (e.g. processor) and other electronic components of real-time analytics appliance 1. Real-time analytics appliance 1 is therefore programmed to custom manage input/output requests and translate these requests into data processing instructions for a central processing unit pursuant to instructions from program software.

Coded data 30 received by real-time analytics appliance 1 from data capturing device 2 is duplicated upon receipt at real-time analytics appliance 1. Once duplicated, coded data 30 can be forwarded from real-time analytics appliance 1 to point-of-sale terminal 11 in its raw form as data 32.

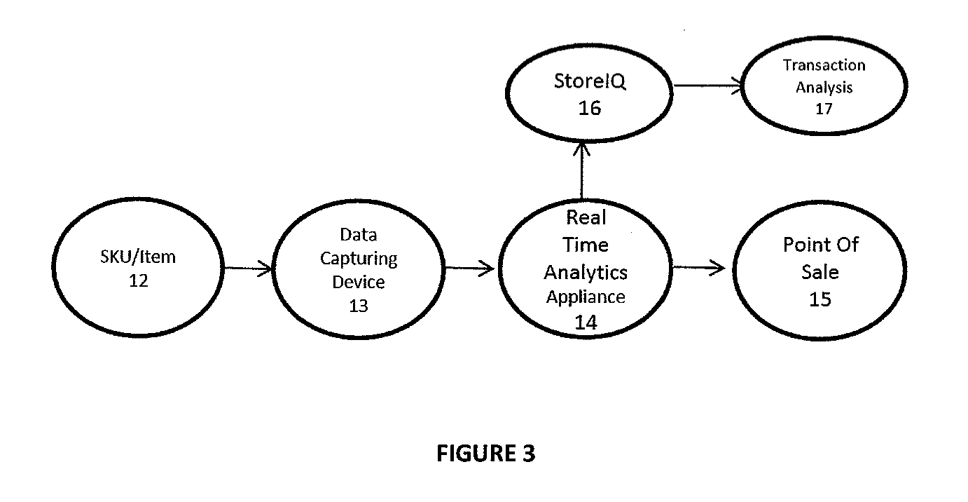

In the example embodiment, real-time analytics appliance 1 is connected to an analysis server 20 (e.g. StoreIQ™; see step 16 of FIG. 3) by an independent connection. This connection can be any wired or wireless connection capable of transferring data from real-time analytics appliance 1. In the embodiment shown in FIG. 2, the independent connection is a 3G/4G cellular connection provided by 3G/4G cellular antenna 8 of real-time analytics appliance 1.

Analysis data 34 is transmitted from real-time analytics appliance 1 to analysis server 20. Data transmission between real-time analytics appliance 1 and analysis server 20 can be by any wireless technology capable of transmitting data. In the example embodiment, data transmission real-time analytics appliance 1 and analysis server 20 occurs over a 3G/4G cellular connection.

Analysis data 34 can include coded data 30 received from data capturing device 2 in its raw form or can include coded data 30 after processing at data capturing device 2 to reveal its coded product information. As previously described, coded data 30 received at real-time analytics appliance 1 from data capturing device 2 can optionally be time-stamped by data capturing device 2 prior to being received by real-time analytics appliance 1. Real-time analytics appliance 1 can also time-stamp coded data 30 in the event that coded data 30 is received without having been time stamped by data capturing device 2. Analysis data 34 therefore can comprise a time-stamp reflecting a time when the respective coded data 30 was captured by data capturing device 2. Analysis data 34 can also comprise a unique identifier of real-time analytic appliance 1 as location information of the location at which coded data 30 was captured.

Analysis server 20 can analyze and compare analysis data 34 with correlations stored at analysis server 20. If analysis data 34 comprises coded data 30 that has not been processed by real-time analytics appliance 1 to reveal product information, coded data 30 can be processed by analysis server 20. Also, analysis server 20 time stamp the coded data 30 upon receipt.

Correlations stored at analysis server 20 can be based on historical product information, time data and location data received and stored at analysis server 20. These correlations can identify trends such as but not limited to sales of certain products at certain locations at specific points in time. Correlations are stored within storage at analysis server 20. Analysis server 20 may also store advertisement material such as but not limited to digital advertisements for display on digital signage (e.g. display 21). Alternatively advertisement material may be stored on a advertisement server (not shown), communicatively coupled to analysis server 20, configured to deliver advertisements in response to the analysis server 20. Other network servers or appliances (e.g. for load balancing, firewalls, etc.) are not shown. Analysis server 20 can process incoming analytics data 34 in real-time, apply stored correlations to analytics data 34 to suggest marketing and/or advertisement materials to present and transmits the marketing and/or advertisement materials in real-time (or via the advertisement server). In the example embodiment marketing and/or advertisement materials are transmitted as advertisement data 36 to real-time analytics appliance 1 in real-time. Real-time analytics appliance 1 can then forward the advertisement data to a display 21 (e.g. a digital display). Display 21 can be connected by any connection capable of transmitting advertising data 38, including but not limited to an RJ45 cable 7 or a HDMI cable 9. Digital display 21 can therefore deliver focused advertisements derived from the transmission of the bar code data 30 in real-time at or near point-of-sale terminal 11.

Marketing and/or advertisement materials can also be transmitted as advertising data 40 over a communication network for display on a third-party means.

Analysis server 20 can also generate reports and correlation information for review by a retailer.

### OPERATION

A non-limiting example of the operation of system 100 is described below. An item for purchase by a consumer is presented to data capture device 2 and a code (e.g. bar code) attached to or otherwise on the product is read using data capture device 2.

Coded data 30 is transferred to real-time analytics appliance 1. Coded data 30 can include a time stamp or can be transferred in its raw form. Real-time analytics appliance 1 duplicates coded data 30. Real-time analytics appliance 1 can process coded data 30 to reveal information about the product presented to the data capture device. Coded data 30 is transmitted in its unprocessed form to point-of-sale terminal 11 as data 32 and in either its processed or unprocessed form to analysis server 20 as analysis data 34. Real-time analytics appliance 1 can also time-stamp coded data 30 and attach time information (e.g. a time-stamp) and location information (e.g. a unique identifier) to analysis data 34.

Analysis data 34 is analyzed at analysis server 20 and compared to pre-configured correlations. Marketing and/or advertising data identified based on the comparison to correlations and transmitted to displays in real-time, either at a display 21 near the point-of-sale terminal 11 through the real-time analysis appliance 1 or over a communication network to a display not connected (e.g. via a cable) to real-time analysis appliance 1.

One implementation of this system is where there are a number of independent stores that belong to a purchasing group. By deploying several real-time analysis appliances 1 in several locations, the purchasing group can effectively understand and monitor product information and product assortment over time.

Another implementation of this system relates to a footprint with a pre-existing piece of digital signage looking to display advertisements based on the real-time capabilities of the system. In this case, the digital signage, which might or might not be by the point of sale, can be controlled when a particular product is scanned and a marketing initiative is coupled with that product.

While the foregoing invention has been described in some detail for purposes of clarity and understanding, it will be appreciated by one skilled in the art, from a reading of the disclosure, that various changes in form and detail can be made without departing from the true scope of the invention in the appended claims.

What is claimed is:

1. A data collection device to capture and distribute in real-time product information of a retail transaction, the device comprising:
a device processor configured to:
receive coded data from a data capturing device, the coded data captured from a product;
transmit the coded data to a point-of-sale terminal; and
transmit the coded data to a server, the server configured to process the coded data to generate the product information, compare the product information to correlations stored at the server, and select advertisement material for display on a digital display in real-time based on the comparison, the advertisement material stored on the server.

2. The data collection device of claim 1 wherein the device processor is further configured to receive the advertisement material selected by the server from the server and transmit the advertisement material to a digital display.

3. The data collection device of claim 1 wherein the device processor is configured to process the coded data to generate the product information prior to transmitting the product data to the server.

4. The data collection device of claim 1 wherein the device processor is further configured to transmit time data with the coded data to the server.

5. The data collection device of claim 4 wherein the device processor is configured to generate the time data.

6. The data collection device of claim 1 wherein the device processor is further configured to transmit location data with the coded data to the server.

7. The data collection device of claim 1 wherein the device processor is configured to emulate a point-of-sale terminal to a product scanner from which the coded data is received.

8. The data collection device of claim 1 wherein the device processor is configured to emulate a product scanner to the point-of-sale terminal to which the coded data is transmitted.

9. A data collection and analysis system to collect and analyze product information from a retail transaction, the system comprising:
an analysis server having one or more processors, wherein the one or more processors are configured to:
receive coded data from a data collection device configured to capture and distribute in real-time product information of a retail transaction;
process the coded data to generate the product information;
compare the product information to correlations stored at the server; and
select advertisement material for display on a digital display in real-time based on the comparison.

10. The data collection and analysis system of claim 9 wherein the correlations stored at the server are based on coded data received at the server.

11. The data collection and analysis system of claim 9 wherein the advertisement material is transmitted to the data collection device for display on a digital display.

12. The data collection and analysis system of claim 9 wherein the coded data is received with time data to compare with the correlations.

13. The data collection and analysis system of claim 9 wherein the coded data is received with location data to compare with the correlations.

14. A method to capture and distribute in real-time product information of a retail transaction, the method comprising:
receiving coded data from a data capturing device, the coded data captured from a product;
transmitting the coded data to a point-of-sale terminal; and
transmitting the coded data to a server, the server configured to process the coded data to generate the product information, compare the product information to correlations stored at the server, and select advertisement material for display on a digital display in real-time based on the comparison, the advertisement material stored on the server.

15. The method of claim 14 comprising receiving the advertisement material and transmitting the advertisement material to the digital display.

16. The method of claim 14 comprising processing the coded data to generate the product information prior to transmitting the product data to the server.

17. The method of claim 14 comprising transmitting time data with the coded data to the server.

18. The method of claim 14 comprising wherein the device processor is further configured to transmit location data with the coded data to the server.

19. The method of claim 14 comprising emulating a point-of-sale terminal to a product scanner from which the coded data is received.

20. The method of claim 14 comprising emulating a product scanner to the point-of-sale terminal to which the coded data is transmitted.
